(19) United States
(12) Patent Application Publication
(10) Pub. No.: US 2021/0373855 A1
(43) Pub. Date: Dec. 2, 2021

(54) Rotation Matrix-Based Factor Graph Cooperative Localization Algorithm

(71) Applicant: Harbin Engineering University, Harbin (CN)

(72) Inventors: Qian SUN, Harbin (CN); Ya ZHANG, Harbin (CN); Zicheng Wang, Harbin (CN); Hongze Gao, Harbin (CN); Guochang Zhang, Harbin (CN); Qingxin Wang, Harbin (CN); Jiachong Chang, Harbin (CN); Shiwei Fan, Harbin (CN)

(21) Appl. No.: 17/236,220

(22) Filed: Apr. 21, 2021

(30) Foreign Application Priority Data
Dec. 24, 2020 (CN) 2020115525991

(51) Int. Cl. G06F 7/78; G06F 7/48; G06F 7/57; G06F 9/30

(52) U.S. Cl. CPC G06F 7/78; G06F 9/30036; G06F 7/57; G06F 7/4818

(57) ABSTRACT

The present disclosure designs a rotation matrix-based factor graph cooperative localization algorithm. Firstly, the reasons of sudden increase in an error in an operation process of a conventional factor graph cooperative localization algorithm are analyzed; secondly, a rotation matrix is designed, and the size of a rotation angle is determined; then, a rotation matrix-based cooperative localization algorithm factor graph model is constructed, and a specific algorithm flow is designed; and finally, filtering fusion estimation is performed on position status information of a slave boat. Therefore, coordinate values of master and slave boats can be transformed within a factor graph in real time without changing the measurement accuracy of an inertial device in a system to cause the coordinates of the master and slave boats that participate in the calculation of the factor graph to be inconsistent, thereby solving the problem of sudden increase in a localization error of the conventional factor graph cooperative localization algorithm, and improving the robustness of the cooperative localization system.

### TECHNICAL FIELD

The present disclosure relates to a cooperative localization technology for an autonomous underwater vehicle (AUV), in particularly, based on a factor graph and a sum product algorithm, coordinate values of master and slave boats are transformed in real time inside a factor graph by means of introducing a rotation matrix, so that coordinates of the master and slave boats that participate in the calculation of the factor graph are inconsistent. When this method is used to perform cooperative localization on an AUV, the problem that a localization error suddenly increases when coordinates of the master and slave boats in a certain direction tend to be the same during cooperative localization with a conventional factor graph method is solved. This method can effectively reduce a cooperative localization error and improve the robustness of a cooperative localization system.

### BACKGROUND

As a booster for humans to explore the ocean, underwater vehicles have experienced a process from birth to development to application. An autonomous underwater vehicle (AUV), as a leader that integrates various cutting-edge technologies in the world today, represents the development direction of underwater vehicles. However, the boundedness of a single AUV working platform in a process of further development and utilization of marine resources is becoming more and more significant. Therefore, the capacity of a multi-AUV cooperative system composed of N sets of AUVs will be far greater than N times that of one AUV by means of sharing data and information of other AUVs. Therefore, in recent years, the research on improving the navigation performance of a single AUV through the cooperation between a plurality of AUVs has attracted people's attention and gradually become a hot spot in the field of AUV navigation. As long as a plurality of AUVs can be directly or indirectly observed relatively, such as measuring a distance or azimuth between them and other AUVs, the navigation statuses of other AUVs can be used to improve their own navigation accuracy. In this way, a cooperative navigation system is formed among the plurality of AUVs. By means of sharing information, the multi-AUV cooperative navigation system can obtain advantages that a single AUV navigation system cannot have: 1) partial AUVs with high-performance navigation equipment share their navigation information through communication to achieve the sharing of their high-performance navigation information in the entire AUV group, so that the overall navigation accuracy of the AUV group is improved; 2) in the multi-AUV cooperative navigation system, as long as partial AUVs have the localization capability with bounded errors, each AUV in the system can have the localization capability with bounded errors by means of cooperative navigation; and 3) the multi-AUV cooperative navigation system has higher fault tolerance and stability.

The cooperative localization algorithm is essentially the problem of filtering. Since a distance observation equation of an underwater cooperative localization system is non-linear, status estimate for the cooperative localization system needs to be implemented with a non-linear filtering algorithm. During use of a factor graph to design the cooperative localization algorithm, the disadvantages of low localization accuracy and large amount of computation of a traditional cooperative localization algorithm under a Gaussian noise condition can be effectively avoided. When the noise in the cooperative localization system is Gaussian noise, a sum product algorithm is used to update information in the factor graph. The factor graph sum product algorithm transforms complex operations into several simple operations. The algorithm does not involve Jacobian matrix operations, thereby reducing the complexity of computation. The factor graph does not need to linearize the distance observation equation, which avoids errors caused by linearization, reduces the cooperative localization error, and improves the localization capability of the cooperative localization system.

However, when an expectation and a variance of a system status variable are used as reliability information of the system for cooperative localization, a problem of sudden increase in the cooperative localization error due to the close or same coordinates of a master boat and a slave boat in a certain direction is prone to occur.

In view of the above existing problems, the present disclosure designs a rotation matrix-based cooperative localization algorithm. The present disclosure uses a factor graph for data fusion, introduces a rotation matrix factor node between an absolute position variable node and a relative position variable node of a status variable, and realizes real-time transformation of coordinate values of the master boat and the slave boat within the factor graph through this node, so that the coordinates of the master and slave boats participating in the calculation of the factor graph are always inconsistent, thereby solving the above problems, and greatly improving the robustness of the cooperative localization algorithm.

### SUMMARY

The present disclosure is directed to design a rotation matrix-based cooperative localization algorithm. A rotation matrix factor node is added into a factor graph model without changing the accuracy of an inertial device to transform coordinate values of master and slave boats within a factor graph in real time, thereby improving the robustness of a system.

The objective of the present disclosure can be realized through the following steps:

step 1: constructing a rotation matrix-based cooperative localization algorithm factor graph model; and

step 2: establishing a rotation matrix-based cooperative localization algorithm, and filtering and updating position status information of a system.

In step 1, an actual working environment of an underwater vehicle is a three-dimensional space, but in consideration that actual depth information can be accurately measured by a pressure sensor in real time, which does not play a role of accumulating a localization error of the vehicle, the cooperative localization is further simplified to a problem under a two-dimensional space. The factor graph is a bipartite model used for expressing a joint probability distribution of a random variable. It includes two types of nodes: one type is a factor node, which refers to a local function in factorization, and the other type is a variable node, which refers to a variable in a global multivariate function. As shown in FIG. 1, the circle in the figure represents the variable node, and the rectangle represents the factor node. In the factor graph, the variable node to the factor node or the factor node to the variable node interact through information. Based on this, a cooperative localization model can be decomposed into two one-dimensional problems. The two one-dimensional problems are respectively expressed by two main node groups in an x coordinate group and a y coordinate group in the factor graph.

Meanwhile, reasons of a sudden increase in an error occurring when a conventional factor graph cooperative localization algorithm taking an expectation and a variance of a status variable as reliability information filters and updates a position status of a system are analyzed, and then a rotation matrix is designed.

Specifically, it is as follows:

(1) Analysis of Error Reasons

In a cooperative localization algorithm factor graph mode as shown in FIG. 1, an updating process of the factor node Eₙ is as follows.

The factor node Eₙ is used to combine a coordinate system of an x group with a coordinate system of a Y group. According to the Pythagorean theorem, the constraint between the variable nodes Δxₙ and Δyₙ can be described as:

dₙ²=Δxₙ²+Δyₙ².

A probability density function transmitted from the factor node Eₙ to the variable node Δyₙ can be expressed as:

$$N ( {Δy}_{n} , \pm \sqrt{{d}_{n}^{2} - {( Δ {x}_{n}^{-} )}^{2}} , \frac{{( Δ {x}_{n}^{-} )}^{2} {σ}_{{x}_{n}^{-}}^{2} + {d}_{n}^{2} {σ}_{{d}_{n}}^{2}}{{d}_{n}^{2} - {( Δ {x}_{n}^{-} )}^{2}} ) ,$$

where Δxₙ⁻ represents an x coordinate difference between a master boat and a slave boat in the previous iteration process; and

σₓ_{ₙ}_{^{−}}² represents a corresponding variance.

A probability density function transmitted from the factor node Eₙ to the variable node Δxₙ can be expressed as:

$$N ( {Δ}_{{X}_{n} ,} \pm \sqrt{{d}_{n}^{2} - {( Δ {y}_{n}^{-} )}^{2}} , \frac{{( Δ {y}_{n}^{-} )}^{2} {σ}_{{y}_{n}^{-}}^{2} + {d}_{n}^{2} {σ}_{{d}_{n}}^{2}}{{d}_{n}^{2} - {( Δ {y}_{n}^{-} )}^{2}} ) ,$$

where Δyₙ⁻ represents an x coordinate difference between a master boat and a slave boat in the previous iteration process; and

σ_{y}_{ₙ}_{^{−}}² represents a corresponding variance.

According to the probability density function transmitted from the factor node to the variable node Δyₙ, an expectation E(Δyₙ) of Δyₙ can be further expressed as:

$$E ( Δ {y}_{n} ) = \pm \sqrt{{d}_{n}^{2} - {( Δ {x}_{n}^{-} )}^{2}} ,$$

A function f(x)=\sqrt{dₙ²−x²} is set, which is subjected to first-order Taylor expansion to obtain:

$$f ( x ) \approx \sqrt{{d}_{n}^{2} - {x}_{0}^{2}} + \frac{{x}_{0}}{\sqrt{{d}_{n}^{2} - {x}_{0}^{2}}} ( x - {x}_{0} ) , \qquad$$

then:

$$f ( {x}_{0} + \tilde{x} ) - f ( {x}_{0} ) \approx \sqrt{{d}_{n}^{2} - {x}_{0}^{2}} + \frac{{x}_{0}}{\sqrt{{d}_{n}^{2} - {x}_{0}^{2}}} \tilde{x} - \sqrt{{d}_{n}^{2} - {x}_{0}^{2}} = \frac{{x}_{0}}{\sqrt{{d}_{n}^{2} - {x}_{0}^{2}}} \tilde{x} . \qquad$$

Due to dₙ²=Δxₙ²+Δyₙ², when y axis coordinates of the master boat and the slave boat tend to be the same, Δyₙ²→0, then dₙ²−Δxₙ²→0, Δxₙ/\sqrt{dₙ²−Δxₙ²}θ∞, and according to the above formulas, a slight error of Δxₙ at this time will cause a great error of E(Δyₙ). This result further leads to the phenomenon that the cooperative localization error suddenly increases when the y axis coordinates of the master boat and the slave boat are close or the same in an actual operation process of the factor graph cooperative localization algorithm taking the expectation and the variance of the status variable as the reliability information.

When the x axis coordinates of the master boat and the slave boat tend to be the same or close, the same as the above, it will cause a greater error of E(Δxₙ), leading to an increase in the localization error.

(2) Design of a Rotation Matrix

The error is caused by the same x axis coordinates or y axis coordinates of the master and slave boats, so that the present disclosure would construct a rotation matrix to transform coordinate values of the master and slave boats within the factor graph in real time and to cause the coordinates of the master and slave boats that participate in the calculation of the factor graph to be inconsistent, thereby solving the problem of sudden increase in the localization error.

A form of the introduced rotation matrix is as follows:

$$C = [ \begin{matrix}cos θ & sin θ \\ - sin θ & cos θ\end{matrix} ] .$$

A determination method for a θ value is as follows:

supposing that the coordinate of a certain master boat is (xₘ,yₘ) and the coordinate of a slave boat is (xₛ,yₛ), the coordinates are transformed into (x′ₘ,y′ₘ) and (x′ₛ,y′ₛ) via a transformation matrix C, and a transformation process is as follows:

$$[ \begin{matrix}{x}_{m}^{′} \\ {y}_{m}^{′}\end{matrix} ] = [ \begin{matrix}cos θ & sin θ \\ - sin θ & cos θ\end{matrix} ] [ \begin{matrix}{x}_{m} \\ {y}_{m}\end{matrix} ] \\ [ \begin{matrix}{x}_{s}^{′} \\ {y}_{s}^{′}\end{matrix} ] = [ \begin{matrix}cos θ & sin θ \\ - sin θ & cos θ\end{matrix} ] [ \begin{matrix}{x}_{s} \\ {y}_{s}\end{matrix} ] .$$

When the estimated coordinate of the slave boat has an error, the following formula is obtained:

$$[ \begin{matrix}{x}_{s}^{′} + \tilde{{x}^{′}} \\ {y}_{s}^{′} + \tilde{{y}^{′}}\end{matrix} ] = [ \begin{matrix}cos θ & sin θ \\ - sin θ & cos θ\end{matrix} ] [ \begin{matrix}{x}_{s} + \tilde{x} \\ {y}_{s} + \tilde{y}\end{matrix} ]$$

where \tilde{x} represents an error of the slave boat at the x axis of the original coordinate system;

\tilde{y} represents an error of the slave boat at the y axis of the original coordinate system;

\tilde{x}′ represents an error of the slave boat at the x axis after the transformation matrix; and

\tilde{y}′ represents an error of the slave boat at they axis after the transformation matrix.

It can be further obtained that:

$$\{ \begin{matrix}\tilde{{x}^{′}} = \tilde{x} cos θ + \tilde{y} sin θ \\ {\tilde{y}}^{′} = - \tilde{x} sin θ + \tilde{y} cos θ\end{matrix} .$$

It can be obtained in combination with the first-order Taylor expansion formula f(x) in (1) that:

$$\{ \begin{matrix}Δ \tilde{x} = \pm \frac{{y}_{m}^{′} - {y}_{s}^{′}}{\sqrt{{d}_{n}^{2} - {( {y}_{m}^{′} - {y}_{s}^{′} )}^{2}}} \tilde{{y}^{′}} \\ Δ \tilde{y} = \pm \frac{{x}_{m}^{′} - {x}_{s}^{′}}{\sqrt{{d}_{n}^{2} - {( {x}_{m}^{′} - {x}_{s}^{′} )}^{2}}} \tilde{{x}^{′}}\end{matrix} .$$

In order to avoid the phenomenon of increase in the error, the following formula needs to be met:

$$\{ \begin{matrix}{d}_{n}^{2} - {( {y}_{m}^{′} - {y}_{s}^{′} )}^{2} \neq 0 \\ {d}_{n}^{2} - {( {x}_{m}^{′} - {x}_{s}^{′} )}^{2} \neq 0\end{matrix} .$$

By means of a constraint relation of the formula dₙ²=Δxₙ²+Δyₙ², the above formula is further simplified into:

$$\{ \begin{matrix}{x}_{m}^{′} - {x}_{s}^{′} \neq 0 \\ {y}_{m}^{′} - {y}_{s}^{′} \neq 0\end{matrix}$$

According to the above formula, conditional expressions that θ should meet are as follows:

$$θ \neq {θ}_{1} , {θ}_{1} = arctan ( \frac{{y}_{s} - {y}_{m}}{{x}_{s} - {x}_{m}} )$$

$$θ \neq {θ}_{2} , {θ}_{2} = arctan ( \frac{{x}_{s} - {x}_{m}}{{y}_{s} - {y}_{m}} ) .$$

In consideration of an actual situation, obviously θ₁≠θ₂, and θ can be selected as:

θ=(θ₁+θ₂)/2.

At this time, θ always meets the above conditions.

In step 2, according to the rotation matrix obtained by analysis and design in step 1, a rotation matrix-based factor graph cooperative localization algorithm is designed, specifically as follows:
a rotation matrix factor node Tᵢ and a transformed coordinate variable node xᵢ are added based on a conventional factor graph cooperative localization algorithm. A probability density function transmitted from the factor node Tᵢ to the variable node xᵢ can be expressed as:

N(xᵢ, x cosθ+y sinθ, σₓ² cos² θ+σ_{y}² sin² θ)

where σₓ² represents a variance transmitted from the variable node x to the factor node Tᵢ; and

σ_{y}² represents a variance transmitted from the variable node y to the factor node Tᵢ.

A probability density function transmitted from the factor node Tᵢ to the variable node yᵢ can be expressed as:

N(yᵢ, −x sinθ+y cosθ, σ_{y}² cos² θ+σₓ² sin²θ).

### BRIEF DESCRIPTION OF FIGURES

FIG. 1 is a constructed rotation matrix-based cooperative localization algorithm factor graph model.

FIG. 2 is a movement path diagram of a master boat and a slave boat in a simulation experiment.

FIG. 3 is a graph showing a localization error in a simulation experiment.

### DETAILED DESCRIPTION

The present disclosure is described in detail below in combination with specific embodiments.

The present disclosure designs a rotation matrix-based factor graph cooperative localization algorithm. Coordinate values of a master boat and a slave boat can be transformed within a factor graph in real time by means of introducing a rotation matrix to cause the coordinates of the master boat and the slave boat that participate in the calculation of the factor graph to be inconsistent, thereby avoiding the phenomenon of sudden increase in a cooperative localization error caused by the fact that the coordinates of the master and slave boats in a certain direction are close or the same in an operation process of the master and slave boats, improving the capability of a cooperative localization system and enhancing the robustness of the system. The objective of the present disclosure can be realized through the following steps:

1. a rotation matrix-based cooperative localization algorithm factor graph model is constructed;

2. a rotation matrix-based factor graph cooperative localization algorithm is established; and

3. filtering fusion estimation is performed on a position status of the system by means of a transmitted probability density function.

In order to verify the effectiveness of the present disclosure, software is used to simulate the rotation matrix-based factor graph cooperative localization algorithm.

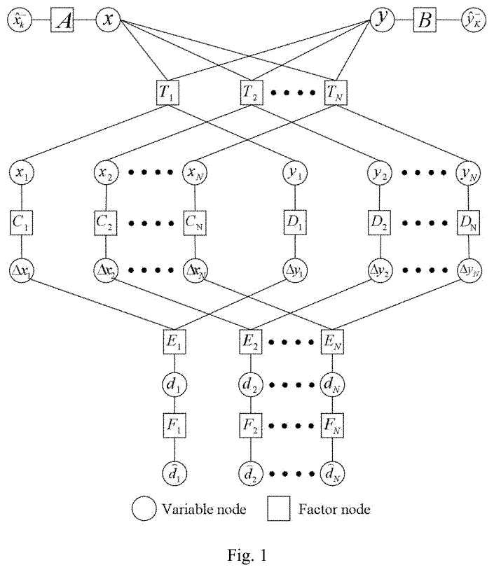

As shown in FIG. 1, the constructed rotation matrix-based cooperative localization algorithm factor graph model is illustrated. In the drawing, (\hat{x}ₖ⁻,ŷₖ⁻) represents one-step forecasting of the position status; (x,y) represents a position status after the filtering fusion estimation; represents a position status processed by the rotation matrix represented by the factor node Tᵢ; (Δx,Δy) represents relative position information between the master and slave boats; \hat{d}ᵢ represents measurement information between the master and slave boats; and dᵢ represents dᵢ=\sqrt{Δx²+Δy²}.

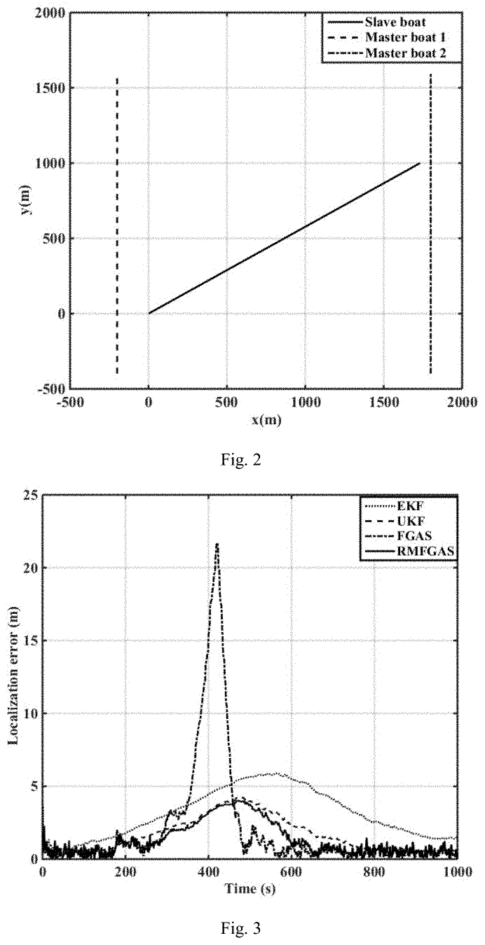

FIG. 2 illustrates movement simulation of the master and slave boats. Simulation conditions: the master boat 1: initial position (xₘ₁,yₘ₁)=(−200 m, −400 m), speed 2 m/s, and heading 90°; the master boat 2: initial position (xₘ₂,yₘ₂)=(1800 m, −400 m), speed 2 m/s, and heading 90°; the slave boat: initial position (0 m, 0 m), speed 2 m/s, and heading 30°. During simulation, speed noise σᵥ²=(0.5 m/s)², acceleration noise σ_{α}²=(0.01 m/s²)², gyroscope measurement noise σ_{ϕ}²=(1°)² and hydroacoustic range observation noise σ_{d}_{₁}²=σ_{d}_{₂}²=(2 m)² of the slave boat are all irrelevant additive noise. A filtering algorithm is used to estimate and update position information, and a cycle for each filtering estimation is 1 s. Moreover, the extended Kalman filter (EKF) algorithm, the unscented Kalman filter (UKF) algorithm and the conventional factor graph cooperative localization (FGAS) algorithm are compared with the rotation matrix-based factor graph cooperative localization (RMFGAS) algorithm designed by the present disclosure.

It can be seen from FIG. 3 that when the system is operated to about 400 s, the localization error of the FGAS algorithm suddenly increases. According to the simulation conditions, elapsed time t when the y axis coordinates of the master boat and the slave boat are the same, can be calculated as:

$$t = \frac{Δ {y}_{0}}{Δ {v}_{y}} = \frac{0 - ( - 400 )}{2 - 2 \times sin ( 3 {0}^{°} )} = 400 s$$

where Δy₀ represents an initial distance between the master boat and the slave boat in a y axis direction; and

Δv_{y} represents a speed difference between the master boat and the slave boat in the y axis direction.

It can be seen that a common factor graph cooperative localization algorithm has the phenomenon of sudden increase in the localization error when the coordinates of the master and slave boats in a certain direction are close or the same. However, the rotation matrix-based factor graph cooperative localization algorithm provided by the present disclosure can always maintain a smaller cooperative error. At the same time, it can be seen that the overall cooperative performance of the RMFGAS algorithm is better than that of the EKF and the UKF. In addition, it should be noted that the localization errors of the RMFGAS algorithm, the EKF algorithm, and the UKF algorithm all increase first and then decrease. This is caused by changes in the observability of the system, and this problem cannot be solved by algorithms.

The above experiments verify the effectiveness of the rotation matrix-based factor graph cooperative localization algorithm of the present disclosure, the coordinate values of the master and slave boats can be transformed within the factor graph in real time without reducing the measurement accuracy of an inertial element in the cooperative system to cause the coordinates of the master and slave boats that participate in the calculation of the factor graph to be inconsistent, thereby solving the problem of sudden increase in the localization error of the conventional factor graph cooperative localization algorithm, which is caused when the coordinates of the master and slave boats in a certain direction are close or the same, and improving the robustness of the cooperative localization system.

What is claimed is:

1. A method, comprising the following steps:
step 1: constructing a rotation matrix-based cooperative localization algorithm factor graph model; and
step 2: establishing a rotation matrix-based cooperative localization algorithm, and filtering and updating position status information of a system.

2. The method according to claim 1, wherein in the step 1, rotation matrix factor nodes are added into a factor graph algorithm flow with the following concept:
distance information of master and slave boats enter the factor graph algorithm flow by means of a node Fᵢ; a priori estimate of a position of the slave boat enters the factor graph algorithm flow by means of nodes A and B; then a position of the slave boat is rotated to change by means of a node Tᵢ; absolute position information of the master and slave boats are transformed into relative position information by means of nodes Cᵢ and Dᵢ; and finally, the position information of the master and slave boats are fused by means of a node Eᵢ.

3. The method according to claim 1, wherein in the step 2, a rotation matrix is constructed and a rotation angle is designed;
a form of the rotation matrix is as follows:
$$C = [ \begin{matrix}cos θ & sin θ \\ - sin θ & cos θ\end{matrix} ] ,$$
a determination method for a value of θ is as follows:
supposing that coordinates of the master boat are (xₘ,yₘ) and coordinates of the slave boat are (xₛ,yₛ), the coordinates are transformed into (x′ₘ,y′ₘ) and (x′ₛ,y′ₛ) via a transformation matrix C through the following transformation process:
$$[ \begin{matrix}{x}_{m}^{′} \\ {y}_{m}^{′}\end{matrix} ] = [ \begin{matrix}cos θ & sin θ \\ - sin θ & cos θ\end{matrix} ] [ \begin{matrix}{x}_{m} \\ {y}_{m}\end{matrix} ] \\ [ \begin{matrix}{x}_{s}^{′} \\ {y}_{s}^{′}\end{matrix} ] = [ \begin{matrix}cos θ & sin θ \\ - sin θ & cos θ\end{matrix} ] [ \begin{matrix}{x}_{s} \\ {y}_{s}\end{matrix} ] ,$$
when estimated coordinates of the slave boat have an error, the following formula is obtained:
$$[ \begin{matrix}{x}_{s}^{′} + {\tilde{x}}^{′} \\ {y}_{s}^{′} + {\tilde{y}}^{′}\end{matrix} ] = [ \begin{matrix}cos θ & sin θ \\ - sin θ & cos θ\end{matrix} ] [ \begin{matrix}{x}_{s} + \tilde{x} \\ {y}_{s} + \tilde{y}\end{matrix} ] ,$$
where \tilde{x} represents an error of the slave boat at an x axis of an original coordinate system;
\tilde{y} represents an error of the slave boat at a y axis of the original coordinate system;
\tilde{x}′ represents an error of the slave boat at the x axis after the transformation matrix;
\tilde{y}′ represents an error of the slave boat at the y axis after the transformation matrix;
an error term can be further calculated as:
$$\{ \begin{matrix}{\tilde{x}}^{′} = \tilde{x} cos θ + \tilde{y} sin θ \\ {\tilde{y}}^{′} = - \tilde{x} sin θ + \tilde{y} cos θ\end{matrix} ,$$
a probability density function transmitted from a factor node Eₙ to a variable node Δyₙ can be expressed as:
$$N ( Δ {y}_{n} , \pm \sqrt{{d}_{n}^{2} - {( Δ {x}_{n}^{-} )}^{2}} , \frac{{( Δ {x}_{n}^{-} )}^{2} {σ}_{{x}_{n}^{-}}^{2} + {d}_{n}^{2} {σ}_{{d}_{n}}^{2}}{{d}_{n}^{2} - {( Δ {x}_{n}^{-} )}^{2}} ) ,$$
where Δxₙ⁻ represents an x coordinate difference between the master boat and the slave boat in a previous iteration process; and
σₓ_{ₙ}_{^{−}}² represents a corresponding variance.
an expectation value E(Δyₙ) of Δyₙ can be further expressed as:
$$E ( Δ {y}_{n} ) = \pm \sqrt{{d}_{n}^{2} - {( Δ {x}_{n}^{-} )}^{2}} ,$$
a function f(x)=√dₙ²−x² is set, and is subjected to first-order Taylor expansion to obtain:
$$f ( x ) \approx \sqrt{{d}_{n}^{2} - {x}_{0}^{2}} + \frac{{x}_{0}}{\sqrt{{d}_{n}^{2} - {x}_{0}^{2}}} ( x - {x}_{0} ) ,$$
then:
$$f ( {x}_{0} + \tilde{x} ) - f ( {x}_{0} ) \approx \sqrt{{d}_{n}^{2} - {x}_{0}^{2}} + \frac{{x}_{0}}{\sqrt{{d}_{n}^{2} - {x}_{0}^{2}}} \tilde{x} - \sqrt{{d}_{n}^{2} - {x}_{0}^{2}} = \frac{{x}_{0}}{\sqrt{{d}_{n}^{2} - {x}_{0}^{2}}} \tilde{x} ,$$
in combination with the above error term, that the following formula is obtained:
$$\{ \begin{matrix}Δ \tilde{x} = \pm \frac{{y}_{m}^{′} - {y}_{s}^{′}}{\sqrt{{d}_{n}^{2} - {( {y}_{m}^{′} - {y}_{s}^{′} )}^{2}}} {\tilde{y}}^{′} \\ Δ \tilde{y} = \pm \frac{{x}_{m}^{′} - {x}_{s}^{′}}{\sqrt{{d}_{n}^{2} - {( {x}_{m}^{′} - {x}_{s}^{′} )}^{2}}} {\tilde{x}}^{′}\end{matrix} ,$$
in order to avoid a phenomenon of increase in the error, the following formula needs to be met:
$$\{ \begin{matrix}{d}_{n}^{2} - {( {y}_{m}^{′} - {y}_{s}^{′} )}^{2} \neq 0 \\ {d}_{n}^{2} - {( {x}_{m}^{′} - {x}_{s}^{′} )}^{2} \neq 0\end{matrix} ,$$
by means of a constraint relation of the formula dₙ²=Δxₙ²+Δyₙ², the above formula is further simplified into:
$$\{ \begin{matrix}{x}_{m}^{′} - {x}_{s}^{′} \neq 0 \\ {y}_{m}^{′} - {y}_{s}^{′} \neq 0\end{matrix} ,$$
according to the above formulas, conditional expressions that θ should meet are as follows:
$$θ \neq {θ}_{1} , {θ}_{1} = arctan ( \frac{{y}_{s} - {y}_{m}}{{x}_{s} - {x}_{m}} )$$
$$θ \neq {θ}_{2} , {θ}_{2} = arctan ( \frac{{x}_{s} - {x}_{m}}{{y}_{s} - {y}_{m}} ) ,$$
in consideration of an actual situation, θ₁≠θ₂, and θ can be selected as:
θ=(θ₁+θ₂)/2.
